(19) United States
(12) Patent Application Publication
(10) Pub. No.: US 2011/0265190 A1
(43) Pub. Date: Oct. 27, 2011

(54) SYSTEM AND METHOD FOR PROCESSING SIGNATURE-VERIFICATION OPERATION

(75) Inventors: Ching-Feng Hsieh, Taipei City (TW); Mei-Yen Chen, Daxi Township (TW)

(73) Assignee: ASKEY COMPUTER CORPORATION, Taipei (TW)

(21) Appl. No.: 12/938,950

(22) Filed: Nov. 3, 2010

(30) Foreign Application Priority Data
Apr. 23, 2010 (TW) 099112807

(51) Int. Cl. G06F 21/24

(52) U.S. Cl. 726/30

(57) ABSTRACT

A system and method for processing a signature-verification operation, includes storing configured categories of signature-verification files and elements with respect thereto, wherein the elements each include at least a signature-verification level and relevant data corresponding thereto; retrieving from the stored signature-verification files and elements a signature-verification file and element corresponding to a request for a signature-verification operation; and executing the signature-verification operation on the signature-verification file according to the retrieved element.

### BACKGROUND OF THE INVENTION

1. Field of the Invention

The present invention relates generally to systems and methods for processing signature-verification operations, and more particularly, to a system and method for processing signature-verification operations based on signature-verification elements corresponding to signature-verification files.

2. Description of Related Art

In corporations, enterprises, associations, government agencies or other organizations, application programs related to staff vacation, material purchase, personnel transfer, process arrangement or design alternation need to be signed-verified by appropriate levels of management.

For example, when an employee applies for vacation, he needs to state the amount of vacation days, dates and reason for vacation on a vacation application form and then sends the form to appropriate levels of management for signature-verification. Along with the development of science and technology, a signature-verification system with simple guiding function is generally applied to rapidly complete the signature-verification operation.

However, along with increasing number of employees, projects or product types, the signature-verification operation is becoming more and more complicated. For example, in a large electronic technology company, an application file provided by a product engineer needs to be signed-verified by appropriate levels of management in R&D department, manufacturing department, testing department, safety department, accounting department and business department. The conventional signature-verification system only having simple guiding function is not suitable to such a complicated signature-verification operation with multiple signature-verification levels. Further, the design is so complicated that some error may occur in the design process, thereby causing an abnormal interruption of the process.

FIG. 1 shows a signature-verification operation process of the conventional signature-verification system. As shown in the drawing, the signature-verification operation process 1 comprises complicated guiding arrows, and different signature-verification operations have different signature-verification procedures. Further, the signature-verification procedures each comprise multiple step directions to different number of signature-verification persons or levels, thereby increasing the workload of program designers and easily resulting in design errors due to the complicated design.

Further, the current signature-verification system does not allow designers to set returning levels in the case that the signature-verification is rejected. Accordingly, no matter the application file is in which level, once the application is rejected by the current level of management, the application file is directly returned to the applicant. However, the reason for rejection is generally not related to the applicant. But the applicant can only send in the application file again and the same signature-verification process is performed again, thereby wasting resources, increasing the workload of the applicant and the signature-verification staff and adversely affecting the signature-verification efficiency.

Therefore, it is imperative to provide a system and method for processing signature-verification operation so as to facilitate the design planning, simplify the process flow, and increase the signature-verification efficiency and signature-verification flexibility.

### SUMMARY OF THE INVENTION

Accordingly, the present invention provides a system for processing a signature-verification operation, which comprises: a configuration module for configuring a plurality of categories of signature-verification files and elements with respect thereto, wherein the signature-verification elements each comprises at least a signature-verification level and signature-verification data corresponding thereto; a storage module for storing the signature-verification files and elements with respect thereto; a receiving module for receiving an inputted request for a signature-verification operation; a selecting module for selecting from the stored signature-verification files in the storage module a signature-verification file corresponding to the request received by the receiving module; a retrieving module for retrieving from the storage module a signature-verification element corresponding to the signature-verification file selected by the selecting module; and an executing module for executing the signature-verification operation on the selected signature-verification file according to the retrieved signature-verification element.

The present invention further provides a method for processing a signature-verification operation, which comprises the steps of: (1) storing a plurality of configured categories of signature-verification files and elements with respect thereto, the signature-verification elements each comprising at least a signature-verification level and signature-verification data corresponding thereto; (2) receiving a request for a signature-verification operation; and (3) retrieving from the stored signature-verification files and elements a signature-verification file and element corresponding to the request so as to execute the signature-verification operation on the signature-verification file according to the retrieved signature-verification element.

The present invention further provides a computer readable record medium storing signature-verification operation programs, wherein the above-described processing method is performed when a computer loads and executes the programs.

The present invention further provides a computer program product storing signature-verification operation programs, wherein the above-described processing method is performed when a computer loads and executes the programs.

Therefore, the present invention simplifies the design and increases the processing flexibility of the signature-verification operations.

### BRIEF DESCRIPTION OF DRAWINGS

FIG. 1 is a diagram showing a conventional method for processing a signature-verification operation;

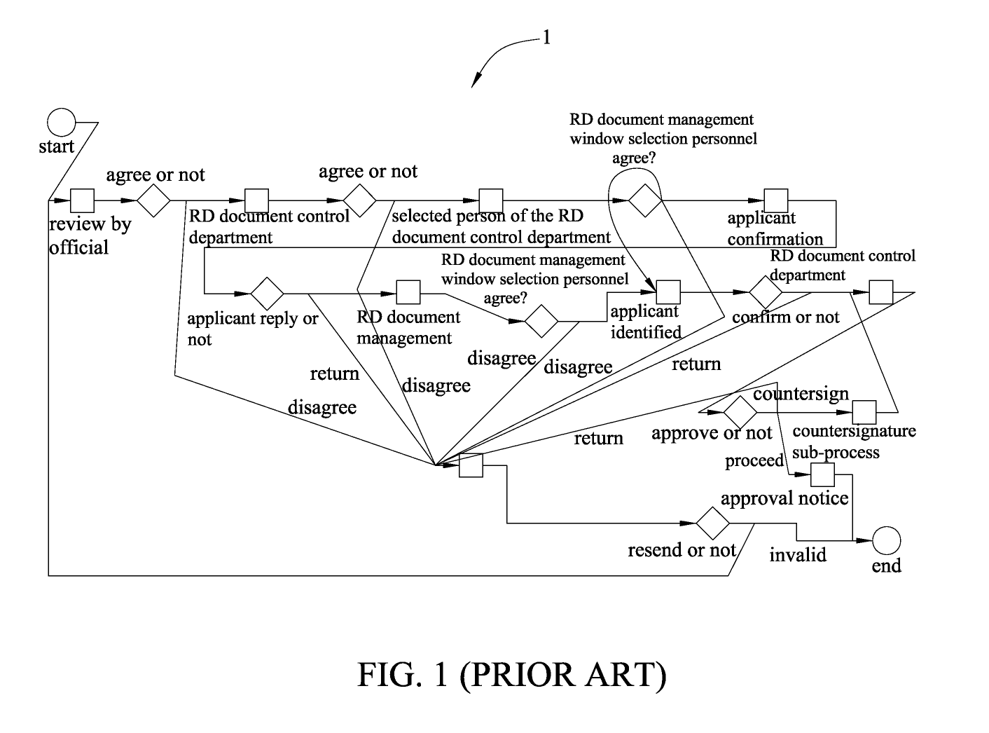

FIG. 2 is a diagram showing the basic structure of a system for processing a signature-verification operation according to the present invention;

FIG. 3A is a diagram showing the data structure of signature-verification elements according to an embodiment of the present invention;

FIG. 3B is a diagram showing the data structure of signature-verification elements according to another embodiment of the present invention;

FIG. 4 is a diagram showing the basic structure and application of a system for processing a signature-verification operation according to another embodiment of the present invention;

FIG. 5 is a diagram showing the process flow of a method for processing a signature-verification operation according to the present invention; and

FIG. 6 is a diagram showing a returning process of the method for processing a signature-verification operation according to the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

### First Embodiment

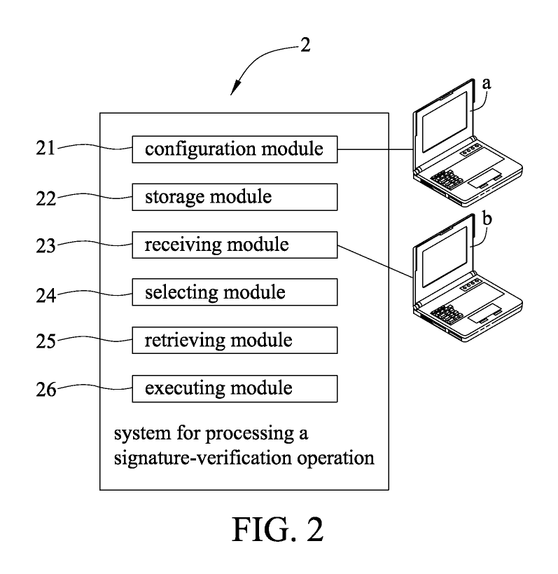

FIG. 2 shows the basic structure of a system for processing a signature-verification operation according to the first embodiment of the present invention. Referring to FIG. 2, the system 2 comprises a configuration module 21, a storage module 22, a receiving module 23, a selecting module 24, a retrieving module 25 and an executing module 26.

The configuration module 21 is used by a program designer at a terminal device to configure a plurality of categories of signature-verification files and elements with respect thereto. Therein, the signature-verification elements each comprise at least a signature-verification level and signature-verification data corresponding thereto. As such, the program designer can configure signature-verification operations on the signature-verification files through the configuration module 21 based on the signature-verification levels and the signature-verification data.

In the present embodiment, the signature-verification files are various kinds of digital signature-verification forms used by an applicant to request for a signature-verification operation. The digital signature-verification forms relate to such as staff vacation, travel expense, material purchase, course training, item loan, design alternation and so on. The signature-verification elements function as a guide for performing a signature-verification operation on the signature-verification files. For example, the signature-verification levels of the signature-verification elements can be staff levels related to the subject matter of the application. The signature-verification data corresponding to the signature-verification levels, respectively, can be event code, event description, refinement code, refinement description, official levels and so on.

In another embodiment, the signature-verification data corresponding to the signature-verification levels further comprises signature-verification modes matching with the signature-verification levels, respectively. For example, if the signature-verification level is set to be an R&D assistant engineer, the official level can be set to be an R&D senior engineer, an R&D associate manager and an R&D manager. Accordingly, the signature-verification mode can be set to be one of the following modes: (1) the R&D senior engineer, the R&D associate manager and the R&D manager execute signature-verification; (2) one of the R&D senior engineer, the R&D associate manager and the R&D manager executes signature-verification; (3) the R&D senior engineer, the R&D associate manager and the R&D manager are informed of the execution of the signature-verification operation. In addition, program designers can configure signature-verification operations on the signature-verification files through the configuration module 21 and according to the signature-verification level and the signature-verification mode of the signature-verification data that have been set.

In another embodiment, the signature-verification data of the signature-verification elements can have a list of signature-verification staff matching with the signature-verification level. For example, if the signature-verification level is an R&D assistant engineer, the list of the signature-verification staff can be an R&D senior engineer, an R&D associate manager and an R&D manager. Program designers can configure signature-verification operations on the signature-verification files through the configuration module 21 and according to the signature-verification level and the list of the signature-verification staff of the signature-verification data that have been set.

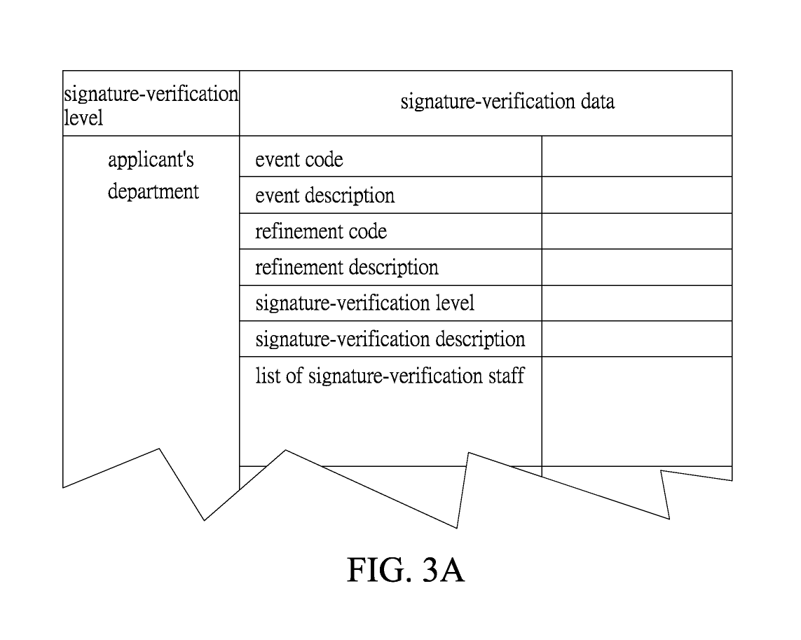

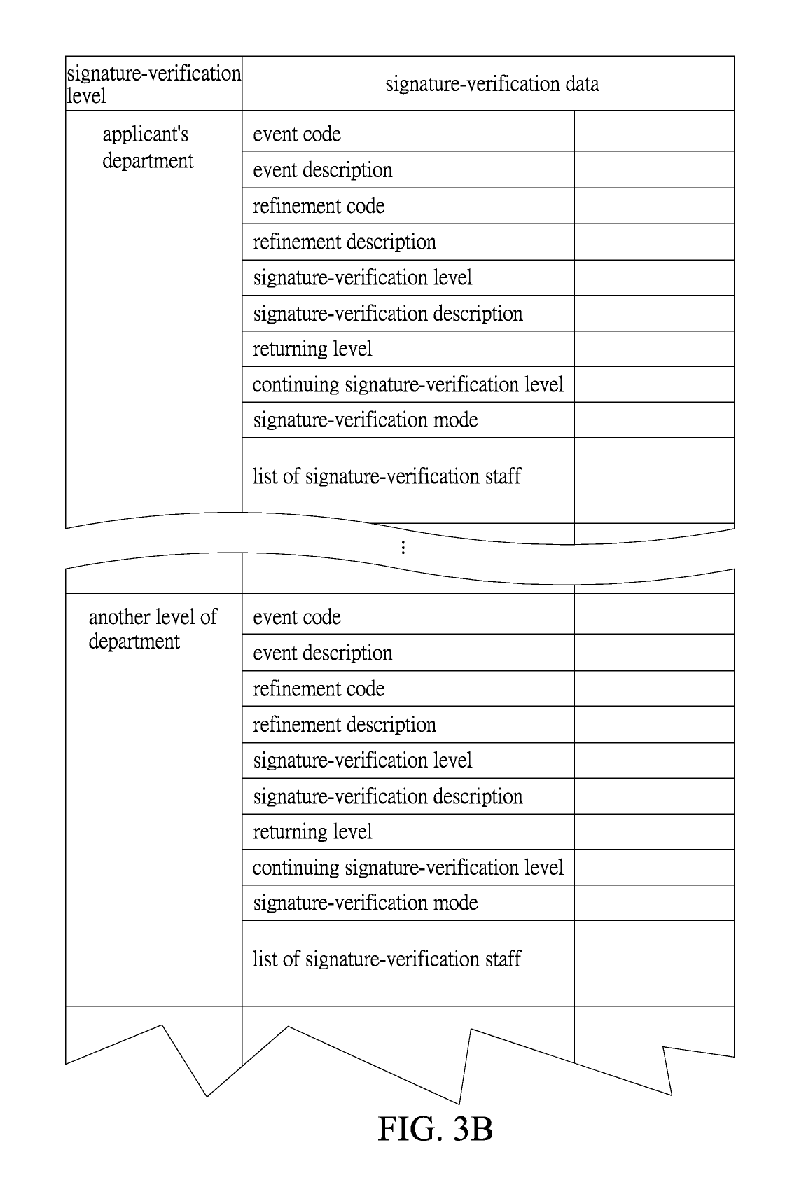

Referring to FIG. 3A, the data structure of the signature-verification elements according to an embodiment of the present invention is shown.

The storage module 22 can store the signature-verification files and the signature-verification elements corresponding to the signature-verification files.

The receiving module 23 receives the request for a signature-verification operation inputted by an applicant at a terminal device b. The request comprises ID data of the applicant and subject matter of the application. For example, if the applicant is an R&D assistant engineer, the inputted ID data can be such as name, job number or code, the subject matter of the application can be such as staff vacation, travel expense, material purchase, course training, item loan, design alternation and so on. In an embodiment, an application form with a document number is provided such that the system 2 can perform the signature-verification operation according to the document number and the received signature-verification request.

The selecting module 24 selects from the signature-verification files stored in the storage module 22 a signature-verification file corresponding to the request received by the receiving module 23. For example, if the applicant is an R&D assistant engineer and the subject matter of the application is job transfer, the selecting module 24 selects from the signature-verification files stored in the storage module 22 a digital signature-verification form specially designed for job transfer application of an R&D assistant engineer.

The retrieving module 25 retrieves from the storage module 22 a signature-verification element corresponding to the signature-verification file selected by the selecting module 24. For example, when the selecting module 24 selects the digital signature-verification form for job transfer application of an R&D assistant engineer, the retrieving module 25 retrieves a signature-verification element corresponding to the digital signature-verification form for job transfer application of an R&D assistant engineer.

The executing module 26 executes a signature-verification operation on the signature-verification file selected by the selecting module 24 according to the signature-verification element retrieved by the retrieving module 25. In the present embodiment, the executing module 26 executes the signature-verification operation on the signature-verification file through a network system (not shown), such as Ethernet, a local area network or an internal network of a company. Continuing the above-described example, the executing module 26 sends the digital signature-verification form to related staff such as a job agent of the R&D assistant engineer or higher levels of officials for signature-verification according to the refinement content of the signature-verification element retrieved by the retrieving module 25.

It should be noted that the system 2 can further comprise a marking module (not shown) for marking, such as encoding, the signature-verification files and elements. As such, according to the mark of a selected signature-verification file, the retrieving module 25 can retrieve from the signature-verification elements stored in the storage module 22 a signature-verification element with the corresponding mark.

In another embodiment, the signature-verification data can further comprise a returning level and/or a continuing signature-verification level matching with the signature-verification level. Program designers can configure returning levels and/or continuing signature-verification levels respectively for all signature-verification levels according to the level of an applicant through the configuration module 21. FIG. 3B shows the data structure of signature-verification elements of the present embodiment. As such, a returning operation on a signature-verification file can be performed. In the present embodiment, the returning level is such as an applicant, the continuing signature-verification level is such as a member of the signature-verification staff who rejects signature-verification. For example, for a abroad business trip application of an applicant, the selecting module 24 provides a abroad business trip file according to the level of the applicant, the retrieving module 25 retrieves from the storage module 22 a signature-verification element corresponding to the business trip abroad file, and the executing module 26 starts up the process of a signature-verification operation according to the retrieved signature-verification element. In particular, the returning level and/or the continuing signature-verification level of the signature-verification data of the signature-verification element are varied according to the level of the applicant and the subject matter of the application. For example, for a five-day business trip abroad application of a manager, if the signature-verification level only relates to a personnel department and the signature-verification person is the personnel manager of the personnel department, the returning level can be set as the manager proposing the application, and if the personnel manager rejects the application, the signature-verification content is returned to the manager who proposes the application and the continuing signature-verification level is set as the personnel manager of the personnel department. Therefore, after the manager proposing the application overcomes the reason for rejection, the executing module 26 continues the signature-verification operation according to the signature-verification element, that is, the application is provided to the personnel manager for signature-verification according to the continuing signature-verification level. In another example, for a five-day business trip abroad application of a group leader of a business department, if the signature-verification level relates to the personnel department and the business department and the signature-verification staff are the director and business manager of the business department and the director and personnel manager of the personnel department, the executing module 26 start up the signature-verification operation according to the signature-verification element corresponding to the group leader, wherein when the director and business manager of the business department execute signature-verification but the director of the personnel department rejects signature-verification, the returning level is set as the group leader proposing the application, and the continuing signature-verification level is set as the director of the personnel department. As such, after the group leader proposing the application overcomes the reason for rejection, the executing module 26 continues the signature-verification operation according to the signature-verification element, that is, the application is provided to the director of the personnel department for signature-verification according to the continuing signature-verification level, thereby eliminating the need to provide the application again to the business department for signature-verification as in the prior art.

The rejected signature-verification content is generally returned to the applicant in this embodiment. But in other embodiments, the returning level can be set by the person who rejects the signature-verification.

Therefore, compared with the prior art, the present invention allows designers to easily and flexibly design signature-verification operations such that the signature-verification operations can be performed conveniently and smoothly.

Further, in the application structure of the system 2, configuration of the signature-verification files and elements is not limited to the terminal device a. In other words, program designers can configure the signature-verification files and elements at the local end of the system 2. Similarly, the application for a signature-verification operation or the signature-verification operation is not limited to the terminal device b. Furthermore, the signature-verification elements can be varied according to the subject matter of the applications and the level of the applicants. That is, the signature-verification elements can selectively comprise event code, event description, refinement code, refinement description, official level, signature-verification mode and list of signature-verification staff matching with the signature-verification level, returning level and continuing signature-verification level matching with the signature-verification level. In other words, the system for processing a signature-verification operation according to the present invention allows users to flexibly adjust the depth and breadth of signature-verification, for example, the number of the signature-verification staff and the number of levels. Therefore, the present invention increases the flexibility and simplifies the process of signature-verification operations, and saves the design time.

### Second Embodiment

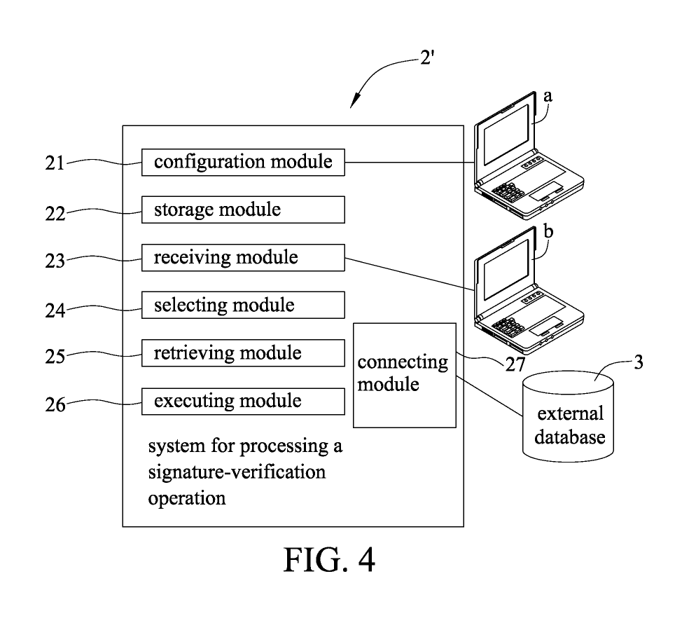

FIG. 4 shows the basic structure of a system for processing a signature-verification operation according to the second embodiment of the present invention. Different from FIG. 2, the system 2′ of the present embodiment further comprises a connecting module 27 for connecting to at least an external database 3. In the present embodiment, the database 3 is such as a staff database, a staff attendance database, a material database or an electronic engineering design database. Therefore, when the executing module 26 executes signature-verification operations according to the signature-verification elements corresponding to the signature-verification files, it can connect to the database 3 so as to acquire data and rapidly configure the signature-verification content. Further, the database 3 can be changed through the connecting module 27 according to the signature-verification content generated by the executing module 26 during the execution of the signature-verification operations. For example, after the system 2′ completes a signature-verification operation according to a vacation application of an applicant, it can update the database 3, such as a staff attendance database, according to the signature-verification content.

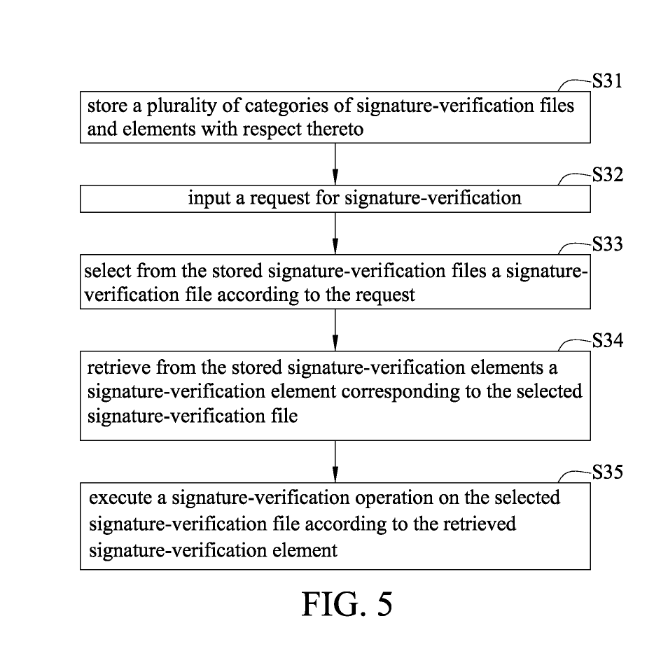

FIG. 5 shows the process flow of a method for processing a signature-verification operation according to the present invention.

First, at step S31, program designers configure and store a plurality of categories of signature-verification files and elements with respect thereto. Then, the process goes to step S32. In the present embodiment, the signature-verification files can be various kinds of digital signature-verification forms used by an applicant to request for a signature-verification operation. The signature-verification elements each comprise at least a signature-verification level and signature-verification data corresponding to the signature-verification level. The signature-verification elements can be stored in the form of a data structure.

At step S32, an applicant inputs a signature-verification request that can comprise ID data of the applicant and subject matter of the application. Then, the process goes to step S33.

At step S33, a signature-verification file corresponding to the request of the applicant is selected from the stored the signature-verification files. Then, the process goes to step S34. In the present embodiment, the signature-verification files can be various kinds of digital signature-verification forms pre-designed by program designers.

At step S34, a signature-verification element corresponding to the selected signature-verification file is retrieved from the stored signature-verification elements. Then, the process goes to step S35.

At step S35, a signature-verification operation on the selected signature-verification file is executed according to the retrieved signature-verification element.

It should be noted that the signature-verification data can selectively comprise signature-verification mode and list of signature-verification staff matching with the signature-verification level. Therefore, at step S31, program designers can selectively match the signature-verification level with the signature-verification mode and the list of the signature-verification staff list so as to configure the signature-verification operation on the signature-verification file.

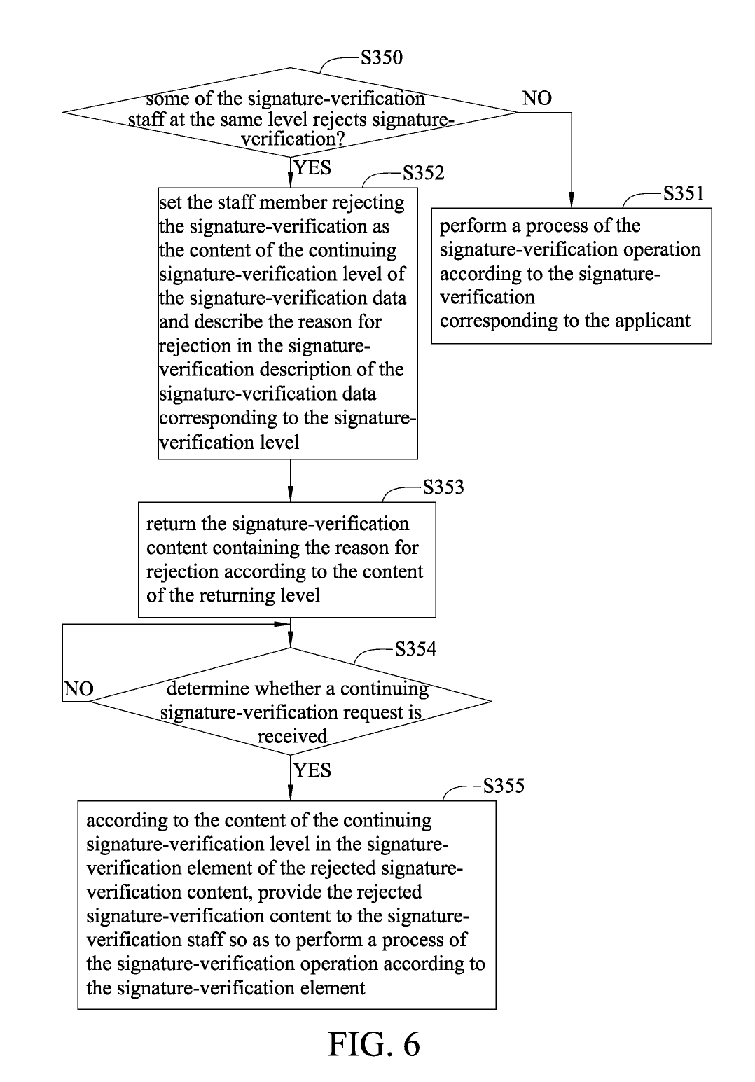

Further, in an embodiment of the present invention, the signature-verification data can comprise a returning level and/or continuing signature-verification level matching with the signature-verification level. Therefore, at step S31, program designers can configure the returning operation on the signature-verification file according to the signature-verification level and the returning level and/or continuing signature-verification level. FIG. 6 shows a returning process of a method for processing a signature-verification operation according to the present invention. At step S350, whether some of the signature-verification staff at a same signature-verification level rejects signature-verification is determined, if yes, the process goes to step S352; otherwise, the process goes to step S351, wherein a process of the signature-verification operation is performed according to the signature-verification element corresponding to the applicant.

At step S352, the signature-verification staff rejecting the signature-verification is set as the content of the continuing signature-verification level of the signature-verification data and the reason for rejection is described in the signature-verification description of the signature-verification data corresponding to the signature-verification level of the signature-verification staff rejecting the signature-verification. Then, the process goes to step S353.

At step 353, the signature-verification content containing the reason for rejection is returned according to the content of the returning level. Generally, the signature-verification content containing the reason is returned to the applicant. However, the returning level can also be set by the signature-verification staff who rejects the signature-verification. Then, the process goes to step S354.

At step S354, whether a continuing signature-verification request is received is determined, if yes, the process goes to step S355, otherwise, the process goes to step S354.

At step S355, according to the content of the continuing signature-verification level in the signature-verification element of the rejected signature-verification content, the rejected signature-verification content is provided to the signature-verification staff so as to perform a process of the signature-verification operation according to the signature-verification element.

It should be noted that the method for processing a signature-verification operation according to the present invention can be applied to the structures of FIGS. 2 to 4. That is, related users can directly perform the present method by using computers or other processing devices. For example, the method of the present invention can be performed by reading and executing programs for processing a signature-verification operation stored in a computer readable record medium, such as a hard disk, a floppy disk, a CD or a portable flash disk, or downloaded from another server through the network system. Therefore, the present invention further provides a computer readable record medium having signature-verification operation programs stored therein or a computer program product having signature-verification operation programs stored therein so as to complete the processes of FIGS. 5 and 6.

Therefore, the present invention simplifies the process flow of signature-verification operations, allows program designers to make simplified process planning so as to improve the signature-verification efficiency, and further facilitates the application of applicants.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. A system for processing a signature-verification operation, comprising:
a configuration module for configuring a plurality of categories of signature-verification files and elements with respect thereto, the signature-verification elements each comprising at least a signature-verification level and signature-verification data corresponding thereto;
a storage module for storing the signature-verification files and elements with respect thereto;
a receiving module for receiving an inputted request for a signature-verification operation;
a selecting module for selecting from the stored signature-verification files in the storage module a signature-verification file corresponding to the request received by the receiving module;
a retrieving module for retrieving from the storage module one of the signature-verification elements corresponding to the signature-verification file selected by the selecting module; and
an executing module for executing the signature-verification operation on the selected signature-verification file according to the retrieved signature-verification element.

2. The system of claim 1, wherein the signature-verification data comprises a signature-verification mode matching with the signature-verification level.

3. The system of claim 1, wherein the signature-verification data comprises a list of signature-verification staff matching with the signature-verification level.

4. The system of claim 1, wherein the signature-verification data comprises a signature-verification mode matching with the signature-verification level and a list of signature-verification staff matching with the signature-verification level, so as for the signature-verification mode to set at least one of the signature-verification staff of the list to perform signature-verification approval, and/or to be informed of the execution of the signature-verification process.

5. The system of claim 1, wherein the signature-verification data comprises a returning level and/or a continuing signature-verification level matching with the signature-verification level so as for the executing module to perform a returning operation on the signature-verification file.

6. The system of claim 1, further comprising a connecting module for connecting with an external database for the executing module to retrieve required data from the external database or store in the external database at least a portion of signature-verification content generated during the execution of the signature-verification operation.

7. The system of claim 1, further comprising a marking module for marking the signature-verification files and elements with respect thereto so as for the retrieving module to retrieve the signature-verification element according to the mark of the selected signature-verification file.

8. The system of claim 1, wherein the storage module stores the signature-verification elements in the form of a data structure.

9. A method for processing a signature-verification operation, comprising the steps of:
(1) storing a plurality of configured categories of signature-verification files and elements with respect thereto, the signature-verification elements each comprising at least a signature-verification level and signature-verification data corresponding thereto;
(2) receiving a request for a signature-verification operation; and
(3) retrieving from the stored signature-verification files and elements a signature-verification file and element corresponding to the request so as to execute the signature-verification operation on the signature-verification file according to the retrieved signature-verification element.

10. The method of claim 9, wherein the signature-verification data comprises a signature-verification mode matching with the signature-verification level and a list of signature-verification staff matching with the signature-verification level, and the signature-verification operation of step (3) is executed by having the signature-verification mode to set at least a signature-verification staff of the list to perform signature-verification approval, and/or to be informed about of the execution of the signature-verification operation.

11. The method of claim 9, wherein the signature-verification data comprises a list of signature-verification staff matching with the signature-verification level, and a returning level and/or a continuing signature-verification level matching with the signature-verification level, and step (3) further comprises the steps of:
(3-1) when one of the signature-verification staff at the signature-verification level rejects signature-verification, the signature-verification staff who rejects the signature-verification is set as content of the continuing signature-verification level of the signature-verification data; and
(3-2) according to content of the returning level of the signature-verification data, the rejected signature-verification is returned to a receiver set by the returning level.

12. The method of claim 11, wherein step (3-1) further comprises having the signature-verification staff rejecting the signature-verification set the content of the returning level of the signature-verification data.

13. The method of claim 9, wherein step (3) further comprises retrieving required data from an external database when executing the signature-verification operation.

14. The method of claim 9, wherein step (3) further comprises storing in an external database at least a portion of signature-verification content generated when executing the signature-verification operation.

15. The method of claim 9, wherein the signature-verification elements are stored in the form of a data structure.
